(19) United States
(12) Patent Application Publication
(10) Pub. No.: US 2026/0365098 A1
(43) Pub. Date: Nov. 19, 2026

(54) PROTECTION DEVICE FOR A RECREATIONAL VEHICLE SLIDE-OUT

(71) Applicant: JNS Enterprises LLC,, Wichita, KS (US)

(72) Inventor: James W. Scrivner, Wichita, KS (US)

(21) Appl. No.: 19/206,601

(22) Filed: May 13, 2025

(51) Int. Cl. B60P 3/34; B60P 3/36

(52) U.S. Cl. CPC B60P 3/34; B60P 3/36

(57) ABSTRACT

A slide-out system for a recreational vehicle (RV), including seal protection devices for protecting a slide-out seal fixed about a slide-out opening or cutout of the RV. The slide-out system further includes the slide-out seal and a slide-out that is slidably attached to the RV. The slide-out extends at least partially out of and retracts into the slide-out opening or cutout. The seal protection devices each include a base panel attached to or integral with an outer surface of the slide-out, a first side panel forming an obtuse angle with the base panel and angled toward the RV, and a second side panel forming an obtuse angle with the base panel and angled away from the RV. The first or second side panels engage with the slide-out seal during extension or retraction of the slide-out, unrolling a wiper of the slide-out seal during extension of the slide-out.

### BACKGROUND OF THE INVENTION

Slide-outs (also called slide rooms or pop-outs) are extendable sections on a recreational vehicle (hereinafter “RV”) that expand outward when the RV is parked, increasing the interior living space. They can be used in a variety of types of RVs, motorhomes, travel trailers, and fifth wheels. When parked, a mechanical or hydraulic system pushes the slide-out section(s) outwards, adding extra space to areas like living rooms, kitchens, bedrooms, and dining areas. Slide-out seals (sometimes called wiper seals or bulb seals) are fastened or otherwise fixed around RV openings through which the slide-outs slide in and out from the RV. The slide-out seals prevent water intrusion, block dirt and debris, maintain climate control, keep out pests, and stop moisture and grit from damaging the slide-out motors, rails, or gears.

Unfortunately, seals wear down over time, particularly due to improper slide-out operation, age, and/or closing the slide-out with debris or contaminants in the way, causing the seal to unevenly stick and release to the side of the slide-out as it is being extended outward and retracted back into the RV. Worn seals with damage such as rippling and uneven wear can create undesired gaps between the seal and the slide-out that let moisture or other undesirable external elements into the RV. Water damage is one of the most expensive repairs in RV ownership. Furthermore, such gaps between the seal and the slide-out can also create more noise from wind whistling through gaps or rattling of loose portions of the seals while driving the RV. While slide-out seals can be replaced, doing so is time intensive, expensive, and can require a high degree of skill.

Thus, there is a need for an improved RV slide-out system that does not suffer from the disadvantages of the prior art RV slide-out systems.

### SUMMARY OF THE INVENTION

Embodiments of the current invention address one or more of the above-mentioned problems and provide a distinct advance in the art of recreational vehicle (RV) slide-out seal protection. In one or more embodiments, a slide-out system for an RV includes a slide-out and one or more seal protection devices. The slide-out may have an outer surface and may extend out of and retract into a slide-out opening or cutout formed through the RV. The one or more seal protection devices each includes a base panel, a first side panel, and a second side panel. The base panel is attached to or integral with the outer surface of the slide-out. The first side panel forms an obtuse angle with the base panel and the second side panel forms an obtuse angle with the base panel. The base panel is located between the first side panel and the second side panel. The first side panel and the second side panel engage with a slide-out seal fixed at least partially around the slide-out opening or cutout during extension or retraction of the slide-out out of or into of the RV.

In other embodiments, a slide-out system for an RV includes at least one structure of the RV defining a slide-out opening or cutout, a slide-out seal fixed to the at least one structure, extending at least partially around the slide-out opening or cutout, a slide-out slidably attached to the at least one structure of the RV, and one or more seal protection devices. The slide-out has an outer surface and selectively extends at least partially out of and retracts into the slide-out opening or cutout. The one or more seal protection devices include a base panel attached to or integral with the outer surface of the slide-out, a first side panel, and a second side panel. The first side panel forms an obtuse angle with the base panel and is angled toward the at least one structure of the RV. The second side panel forms an obtuse angle with the base panel and is angled away from the at least one structure of the RV. The first side panel is sized and positioned to engage with the slide-out seal during extension of the slide-out at least partially out of the slide-out opening or cutout. The second side panel is sized and positioned to engage with the slide-out seal during retraction of the slide-out into the slide-out opening or cutout.

In yet another embodiment, a method for protecting a slide-out seal fixed about a slide-out opening or cutout of an RV includes attaching at least one seal protection device to an outer surface of a slide-out, rolling a wiper portion of the slide-out seal toward the RV, and unrolling the wiper portion of the slide-out seal away from the RV. The seal protection device includes a base panel, a first side panel forming an obtuse angle with the base panel, and a second side panel forming an obtuse angle with the base panel. The base panel is located between the first side panel and the second side panel. Rolling the wiper portion toward the RV is performed by retracting the slide-out into the RV through the slide-out opening or cutout such that at least one of the first side panel and the second side panel contact the wiper portion of the slide-out seal. The unrolling the wiper portion away from the RV is performed by extending the slide-out outward through the slide-out opening or cutout such that at least one of the first side panel and the second side panel contact the wiper portion of the slide-out seal.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is an end plan view of a seal protection device constructed in accordance with embodiments herein;

FIG. 2 is a perspective view of the seal protection device of FIG. 1;

FIG. 3 is a fragmentary perspective view of a recreational vehicle (RV) with multiple ones of the seal protection device of FIG. 1 attached to a slide-out in its fully extended configuration in accordance with embodiments herein;

FIG. 4 is a close-up fragmentary perspective view of the slide-out of FIG. 3 and a slide-out seal associated therewith in accordance with embodiments herein; and

FIG. 5 is a block diagram of a method for protecting the slide-out seal of FIG. 4 with the seal protection device of FIG. 1 in accordance with embodiments herein.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Recreational vehicles (hereinafter “RVs”) are motorized or towable vehicles that combine transportation and living quarters, designed for travel, camping, and extended stays. RVs can include sleeping accommodations such as beds or convertible furniture, kitchen facilities like a sinks or refrigerators, bathrooms, living space, and slide-outs. Slide-outs (also called slide rooms or pop-outs) are extendable sections of the RV that expand outward when the RV is parked, increasing the interior living space. When parked, a mechanical or hydraulic system pushes the slide-out section(s) outwards, adding extra space to areas like living rooms, kitchens, bedrooms, and dining areas. Slide-outs are typically operated by a button inside the RV or even remote or app control. Slide-out openings or cutouts in the RV may be framed with structural reinforcement to maintain the RV’s rigidity and strength when the slide-out is extended or retracted therethrough. For example, one or more structures (e.g., an RV wall, frame, or the like) of the RV may have the slide-out openings or cutouts formed therethrough. Furthermore, the slide-out openings or cutouts can include seals, flanges, and/or gaskets to help keep the area weatherproof and secure.

Specifically, slide-out seals (sometimes called wiper seals or bulb seals) are fastened or otherwise fixed around the slide-out openings or slide-out cutouts of the RV. These seals can be made of rubber or other such flexible material, similar to the material contacting windshields for wiper blades. The slide-out seals prevent water intrusion, block dirt and debris, maintain climate control, keep out pests, and stop moisture and grit from damaging the slide-out motors, rails, or gears. Improper slide-out operation and/or closing the slide-out with debris or contaminants in the way can cause the slide-out seals to unevenly stick and release to the side of the slide-out as it is being extended outward and retracted back into the RV. This can cause undesirable rippling, uneven wear, or even tearing of the slide-out seals. In some cases, the slide-out seals can even roll up or fold up onto themselves even as the slide-out is extended, which disadvantageously causes the slide-out seal to tear or wear out quickly.

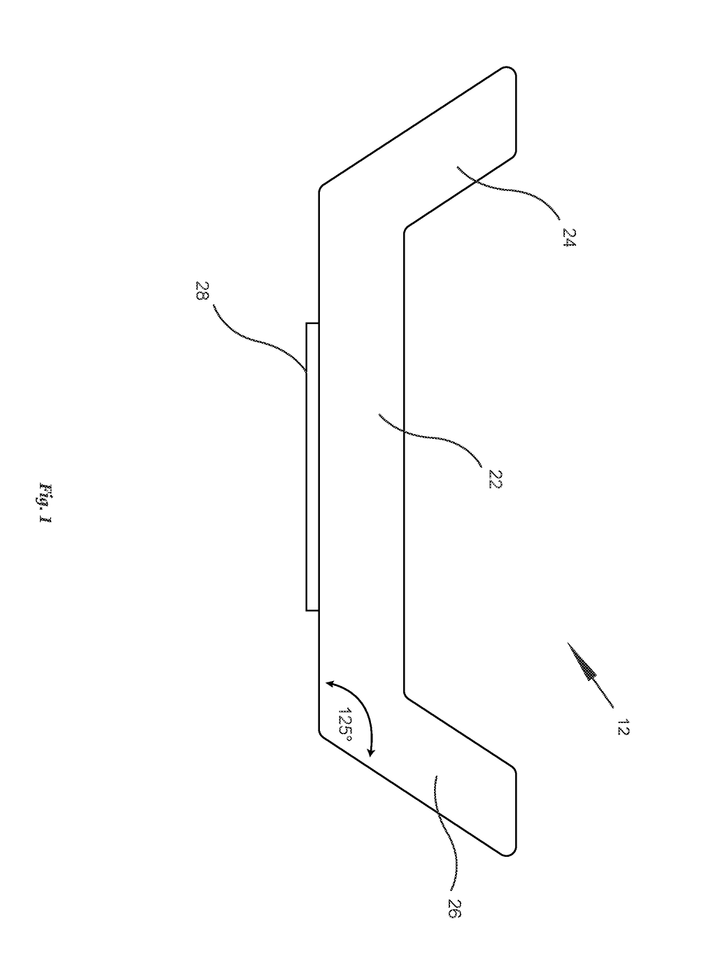

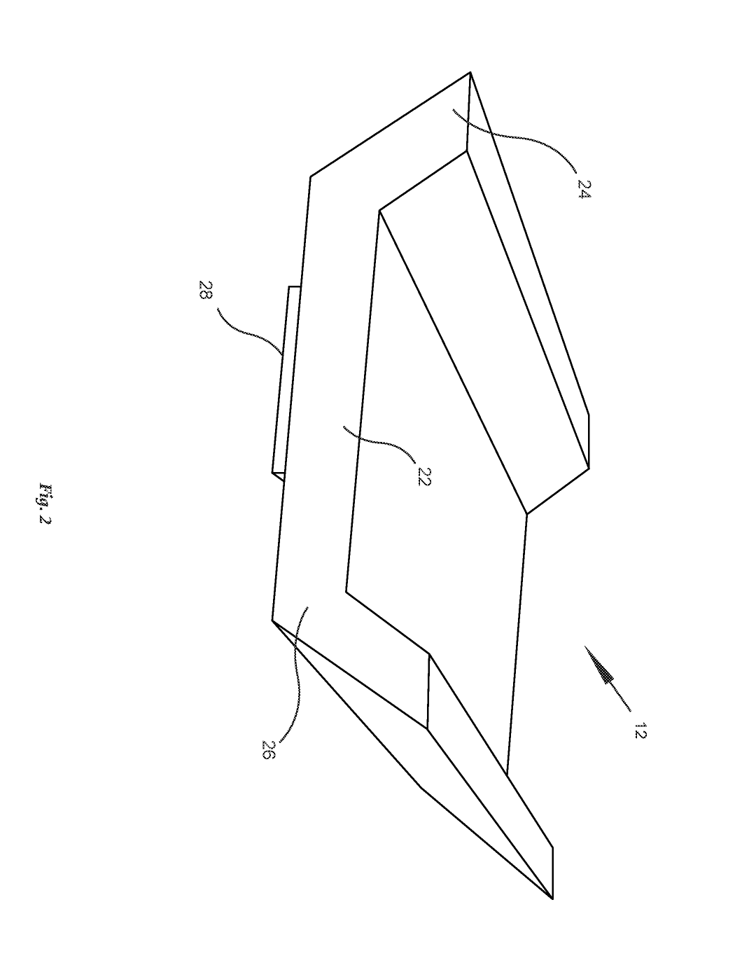

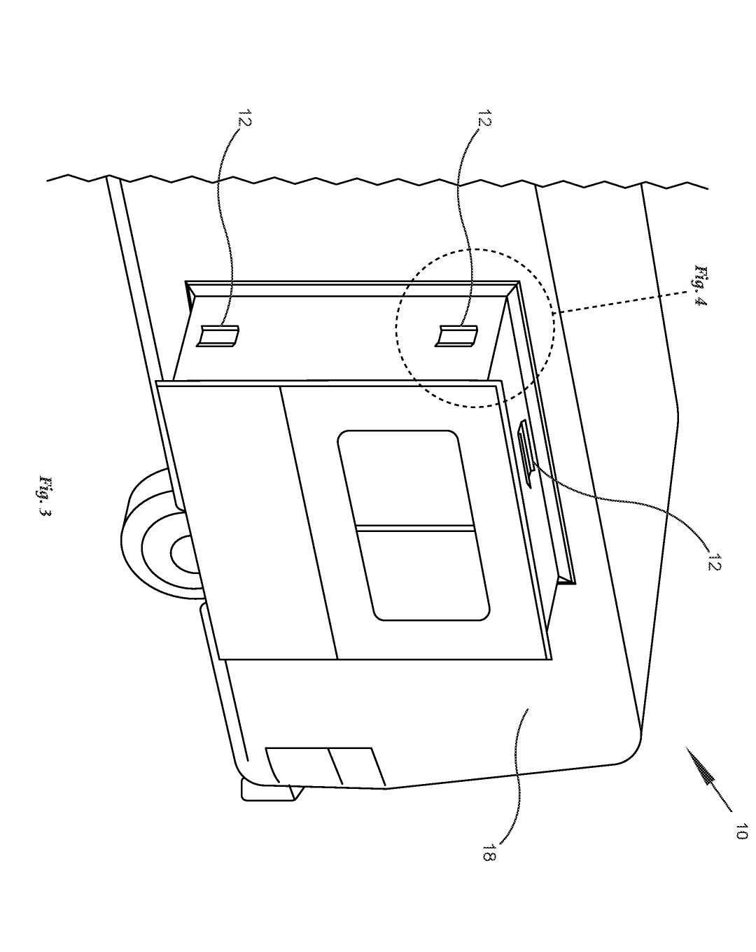

However, as depicted in FIGS. 1-4, a slide-out system 10 of the present invention provides a seal protection device 12 for attachment to an outer surface of a slide-out 14 that is designed and configured to make contact with a slide-out seal 16 during extension and retraction of the slide-out 14. The seal protection device 12 prevents the roll-up phenomenon of the slide-out seal 16 that causes uneven wear and tearing by guiding the slide-out seal 16 into a substantially rolled-out and/or flattened configuration as the slide-out 14 is extended outward from an RV 18 (see FIG. 3) or retracted back in through slide-out openings or cutouts 20 of the RV 18.

The slide-out system 10 may include a plurality of seal protection devices (e.g., the seal protection device 10). The seal protection device 12 may be made of a rigid material such as a bonded plastic. In one or more embodiments, the seal protection device 12 may be made of fiberglass, aluminum, carbon fiber, or plastic. The seal protection device 12 may be an elongated device extending along a length-wise axis and in one or more embodiments may have a length of approximately 8 inches to approximately 10 inches, or any desired length. The length-wise axis of the seal protection device 12 may be configured to be oriented vertically or horizontally on a slide-out’s outer walls (e.g., top, bottom, right side, left side), depending upon an orientation of the slide-out seal 16 to be engaged by the seal protection device 12, as later described herein. For example, the seal protection device 12 may be mounted such that the length-wise axis is substantially vertical along outer side walls of the slide-out 14 or may be mounted such that the length-wise axis is substantially horizontal along outer top and/or outer bottom walls of the slide-out 14.

The seal protection device 12 may present three walls or flanges angled relative to each other. For example, the seal protection device 12 may have a cross-sectional configuration of a trapezoid (when cut perpendicular to the length-wise axis) without a top side, but including a bottom side and two non-parallel sides joined at opposing ends of the bottom side at obtuse angles. In some embodiments, the seal protection device 12 may have a base panel 22, a first side panel 24 angled away from the slide-out 14 and forming a first joint, bend, or crease at a first end of the base panel 22, and a second side panel 26 angled away from the slide-out and forming a second joint, bend, or crease at a second end of the base panel 22.

The first side panel 24 may form an obtuse angle with the base panel 22 and may be angled toward the RV or a frame or structure thereof. The second side panel 26 may form an obtuse angle with the base panel 22 and may be angled away from the RV or a frame or structure thereof. The base panel 22 is located between the first side panel 24 and the second side panel 26. The first side panel 24 and the second side panel 26 are configured (e.g., sized and positioned) to engage with or contact the slide-out seal 16 during extension or retraction of the slide-out 14 partially out of or into of the RV, as later described herein.

As depicted in FIG. 1, in some example embodiments, the seal protection device’s first and second side panels 24,26 may be angled approximately 125 degrees (plus or minus 5 degrees) away from the base panel 22. In some embodiments, the first and second side panels 24,26 may be less than half a width of the base panel’s width. However, other angles and relative sizes between the angled panels of the seal protection device 12 may be used without departing from the scope of the technology disclosed herein.

A back side of the base panel 22 may be substantially flat or otherwise contoured or configured to rest against an outer surface of the slide-out 14 and may be fixed thereto with a sealant, sticky tape, adhesive, and/or mechanical fasteners. For example, the seal protection devices 12 may be configured to stick on the slide-out 14 with an adhesive backed tape 28 that is durable and substantially weather-proof.

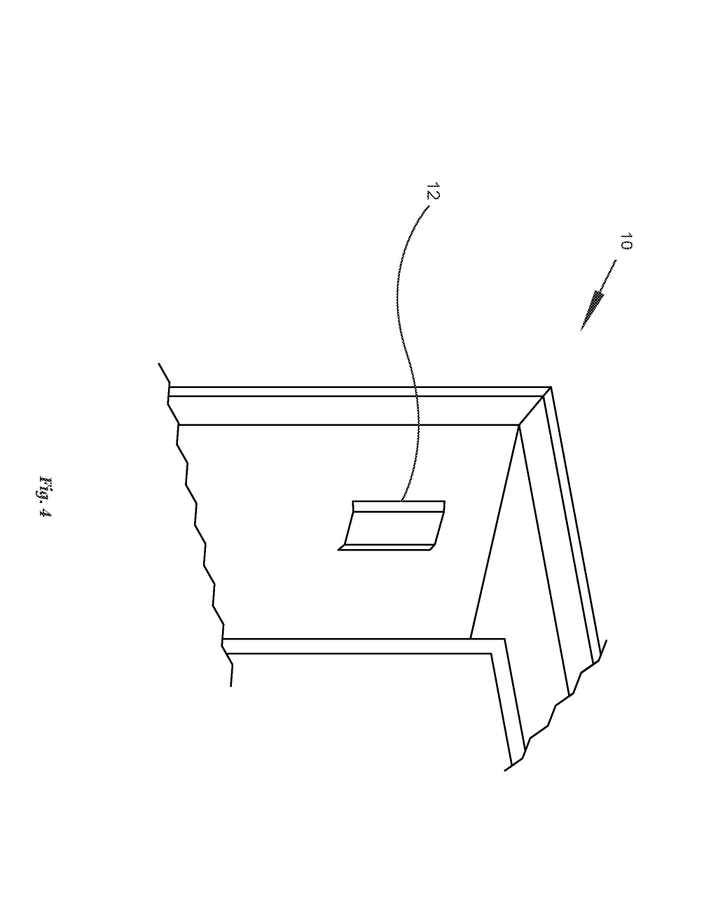

The slide-out seal 16 may be made of rubber or any known material used for slide-out seals, such as thermoplastic elastomers (TPE) or Ethylene Propylene Diene Monomer (EPDM) rubber. The slide-out seal 16 may be a double bulb or single bulb seal with at least one bulb portion 30 and a wiper portion 32. Additionally or alternatively, the slide-out seal 16 may include any other type of seal known in the art of RV slide-outs. Any seal with a wiper portion that rolls out and/or lays substantially flat against the slide-out or makes contact with the slide-out during extension and retraction of the slide-out 14 may be used without departing from the scope of the technology herein. Note that in the rolled-out or flattened configuration, the wiper portion 32 of the slide-out seal 16 is not necessarily completely flat against the slide-out 14 but rather can extend along a concave curvature from the bulb portion 30 to the slide-out 14, as depicted in FIG. 4. That is, the term “flattened” may be used herein to mean that the wiper portion 32 is not curved inward, folded over itself, or rolled up toward the RV 18 or structures thereof.

In use, the slide-out seal 16 is fixed to a frame or otherwise fixed at a perimeter of the slide-out openings or cutouts 20 of the RV 18. The seal protection devices 12 may be attached to the outer surfaces of the slide-out 14 when in an extended position or extended configuration. The slide-outs 14 may be extended or retracted using a manual or automated system. During slide-in or retraction for storage purposes (e.g., when the RV 18 is traveling) and/or during slide-out or extension for use of space within the slide-out 14 (e.g., when the RV 18 is parked), the first and/or the second side panels 24,26 catch or otherwise contact the wiper portion 32 of the slide-out seal 26, preventing it from curling onto itself.

When the slide-out 14 is fully extended outward from the slide-out openings or cutouts 20, the seal protection device 12 or a plurality of the seal protection devices 12 may each be located a short distance (e.g., about 8-inches) away from the frame / RV structure and/or the slide-out openings or cutouts 20 of the RV 18. However, a customer or user can put as many seal protection devices 12 as needed or desired on the slide-out’s outer surface, preferably at an orientation that mirrors an orientation of the slide-out seals 16. In some embodiments, the seal protection devices 12 only need to make contact within a first couple of inches when the slide-out 14 starts to hit the slide-out seal 16. As long as the seal protection devices 12 hit or make contact with the slide-out seal 16 at some point along a path of the extension or retraction motion of the slide-out 14, the seal protection devices 12 can assist in preventing the slide-out seals 16 from rolling up onto themselves during extension and assist in an even, purposeful rolling or folding up during retraction.

In some embodiments, each of the seal protection devices 12 have relatively low clearance (e.g., less than 1 inch or less than 0.7 inches) when attached to the outer surfaces of the slide-out 14 so that the seal protection devices 12 do not get caught up during extension, retraction, or while stored within the RV 18. In one or more embodiments, vertical sidewalls of the slide-out 14 may have one of the seal protection devices 12 located at or proximate to a top edge or within a top half portion thereof and one of the seal protection devices 12 located at or proximate to a bottom edge or within a bottom half portion thereof to cooperatively unroll the slide-out seal 16 (e.g., the wiper portion 32 thereof) out during extension of the slide-out 14 and roll or fold the slide-out seal 16 (e.g., the wiper portion 32 thereof) during retraction of the slide-out 14.

The first and second side panels 24, 26 and the base panel 22 cooperatively allow the slide-out seal 16 to effortlessly roll onto the slide-out or an outer surface thereof. Specifically, the slide-out seal’s wiper portion 32 may catch on the second side panel 26 and flatten out against the angled inner surface of the first side panel 24 during extension of the slide-out 14. When the slide-out 14 is retracted back into the RV 18, the slide-out seal’s wiper portion edge may hit or contact the first side panel 24 and roll back inward, forming a secure seal between the slide-out 14 and the RV 18. Advantageously, the seal protection devices 12 will help prevent slide-out seal damage and also prolong the life of the slide-out seals 16.

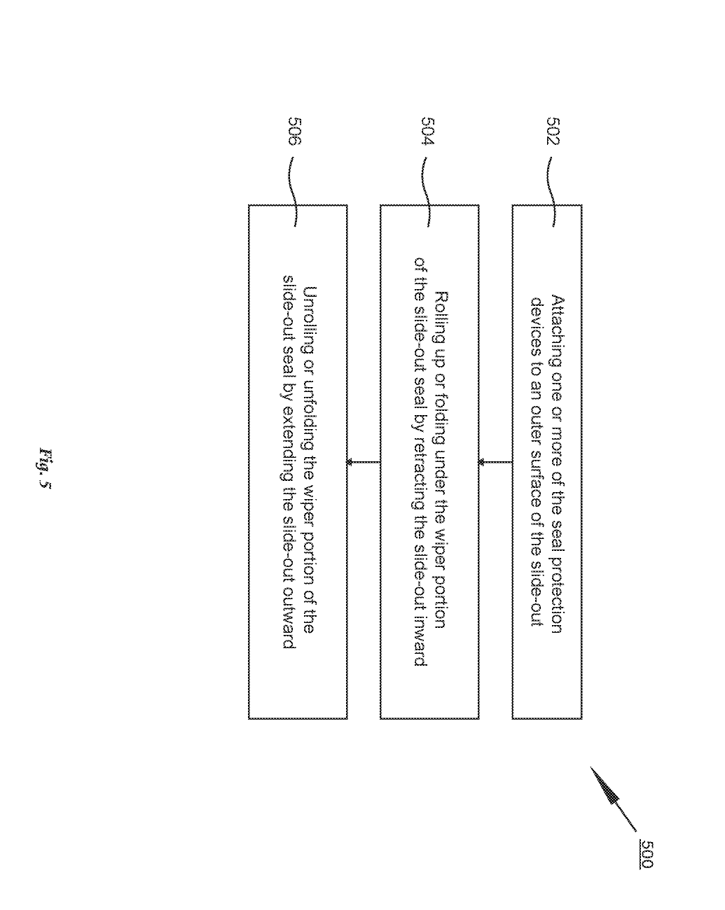

The flow chart of FIG. 5 depicts an exemplary method 500 for protecting a slide-out seal (e.g., the slide-out seal 16) during extension and retraction of a slide-out in more detail. In some embodiments, various steps may be omitted, or steps may occur out of the order depicted in FIG. 5 without departing from the scope of the technology as described herein. For example, two blocks shown in succession in FIG. 5 may in fact be executed substantially concurrently, or blocks may sometimes be executed in the reverse order depending upon the functionality involved.

The method 500 may include attaching one or more of the seal protection devices 12 to an outer surface of the slide-out 14, as depicted in block 502. This may include attaching the seal protection device 12 or multiple ones of the seal protection device 12 to the outer surface or a plurality of faces of the outer surface of the slide-out 14. In some embodiments, sealant or adhesive (e.g., adhesive backing or adhesive backed tape 28) is used on a back surface of the base panel 22 of the seal protection devices 12 to attach or affix the seal protection devices 12 to the slide-out 14. In other embodiments, the base panel 22 is integral with the outer surface of the slide-out 14. At least a portion of the outer surface of the slide-out 14 faces toward the slide-out seal 16 during the retracting and extending of the slide-out 14, so by attaching the seal protection devices 12 to this outer surface, the seal protection devices 12 contact the slide-out seal 16 during retraction and extension of the slide-out 14, as further described below.

For example, the outer surface of the slide-out 14 may include a top, bottom, and two opposing side surfaces, some or all of which may have the seal protection devices 12 attached thereto via the method 500 disclosed herein. In some embodiments, attaching the seal protection device 12 comprises attaching a first seal protection device and a second seal protection device vertically or horizontally aligned with each other on a single face of the outer surface of the slide-out 14 along a device axis that is substantially parallel to a seal axis of the slide-out seal 16. This configuration allows a top and a bottom of a seal, for example, to simultaneously be flattened out / unrolled or rolled up by the first and/or second side panels 24,26, such that a portion of the slide-out seal 16 between the two seal protection devices 12 also is simultaneously flattened out / unrolled or rolled up, respectively. However, other quantities of seal protection devices 12 may be applied along one or more axes without departing from the scope of the technology herein. In some embodiments, attaching the seal protection device 12 further comprises attaching at least two seal protection devices 12 on each of or any combination of the top surface, the bottom surface, and the two opposing side surfaces of the slide-out 14.

The method 500 may further include rolling the wiper portion 32 of the slide-out seal 16 by retracting the slide-out 14 into the RV 18 through the slide-out opening or cutout 20, as depicted in block 504. That is, the slide-out 14 may be retracted such that at least one of the first side panel 24 and the second side panel 26 contact the wiper portion 32 of the slide-out seal 16, pushing the wiper portion 32 to roll and/or fold inward toward the RV’s interior. For example, an end of the wiper portion 32 may contact the first side panel’s outer surface, which then pushes the end of the wiper portion 32 inward toward the RV 18 as the slide-out 14 retracts thereinto.

The method 500 may further include unrolling the wiper portion 32 of the slide-out seal 16 by extending the slide-out 14 outward in a direction away from the RV 18, as depicted in block 506. Specifically, the slide-out 14 may be slid until it extends outward at least partially through the slide-out opening or cutout 20. Once the wiper portion 32 of the slide-out seal 16 makes contact with the first side panel 24 and/or the second side panel 26, the wiper portion 32 may be unrolled or flattened by said contact. That is, the first side panel 24 and/or the second side panel 26 contact and guide / unroll / flatten out (or at least partially flatten out) the slide-out seal 16 or the wiper portion 32 thereof into a rolled-out or fully-extended configuration as the slide-out 14 is extended outward. For example, the wiper portion 32 may be rolled or folded over onto itself as the slide-out 14 begins to extend, then may contact an end of the second side panel 26, which then pulls the wiper portion 32 outward as the slide-out 14 continues to slide outward, until the slide-out seal’s wiper portion 32 unrolls or substantially flattens out by the time it passes the first side panel 24, such that once the seal protection device 12 has moved along with the slide-out 14 beyond the slide-out seal 16, the wiper portion 32 rests in an unrolled / flattened or fully-extended configuration against the outer surface of the slide-out 14.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A slide-out system for a recreational vehicle (RV), the slide-out system comprising:
a slide-out having an outer surface and configured to extend out of and retract into a slide-out opening or cutout formed through the RV; and
one or more seal protection devices each comprising:
a base panel attached to or integral with the outer surface of the slide-out,
a first side panel forming an obtuse angle with the base panel, and
a second side panel forming an obtuse angle with the base panel, wherein the base panel is located between the first side panel and the second side panel, wherein the first side panel and the second side panel are configured to engage with a slide-out seal fixed at least partially around the slide-out opening or cutout during extension or retraction of the slide-out out of or into of the RV.

2. The slide-out system of claim 1, wherein the first side panel and the second side panel are integrally formed with the base panel.

3. The slide-out system of claim 1, further comprising an adhesive securing the base panel of the one or more seal protection devices to the outer surface of the slide-out.

4. The slide-out system of claim 1, wherein the first side panel and the second side panel extend from the base panel at a height that is less than the width of the base panel.

5. The slide-out system of claim 1, further comprising:
at least one structure of the RV defining the slide-out opening or cutout through which the slide-out extends and retracts; and
the slide-out seal fixed to the at least one structure and extending at least partially around the slide-out opening or cutout, and configured to contact the one or more seal protection devices as the slide-out extends or retracts.

6. The slide-out system of claim 5, wherein the slide-out seal comprises a wiper portion configured to make contact with the one or more seal protection devices during extending of the slide-out and unroll or extend outward via the contact with the one or more seal protection devices.

7. The slide-out system of claim 1, wherein the one or more seal protection devices comprise a first seal protection device and a second seal protection device vertically or horizontally aligned with each other on a single face of the outer surface of the slide-out along an axis that is substantially parallel with the slide-out seal.

8. The slide-out system of claim 1, wherein the base panel has a length and a width, wherein the length is greater than the width.

9. A slide-out system for a recreational vehicle (RV), the slide-out system comprising:
at least one structure of the RV defining a slide-out opening or cutout;
a slide-out seal fixed to the at least one structure, extending at least partially around the slide-out opening or cutout;
a slide-out slidably attached to the at least one structure of the RV, having an outer surface, and configured to extend at least partially out of and retract into the slide-out opening or cutout; and
one or more seal protection devices, each comprising:
a base panel attached to or integral with the outer surface of the slide-out,
a first side panel forming an obtuse angle with the base panel and angled toward the at least one structure of the RV, wherein the first side panel is sized and positioned to engage with the slide-out seal during extension of the slide-out at least partially out of the slide-out opening or cutout, and
a second side panel forming an obtuse angle with the base panel and angled away from the at least one structure of the RV, wherein the second side panel is sized and positioned to engage with the slide-out seal during retraction of the slide-out into the slide-out opening or cutout.

10. The slide-out system of claim 9, further comprising an adhesive securing the base panel of the one or more seal protection devices to the outer surface of the slide-out.

11. The slide-out system of claim 9, wherein the one or more seal protection devices comprise a first seal protection device and a second seal protection device vertically or horizontally aligned with each other on a single face of the outer surface of the slide-out along an axis that is substantially parallel with the slide-out seal.

12. The slide-out system of claim 9, wherein the first side panel and the second side panel extend from the base panel at a height that is less than the width of the base panel.

13. The slide-out system of claim 9, wherein the slide-out seal comprises a wiper portion configured to make contact with the first side panel or the second side panel during extending of the slide-out and to unroll or extend outward via the contact with the first side panel or the second side panel.

14. The seal protection device of claim 9, wherein the base panel has a length and a width, wherein the length is greater than the width.

15. A method for protecting a slide-out seal fixed about a slide-out opening or cutout of a recreational vehicle (RV), the method comprising:
attaching at least one seal protection device to an outer surface of a slide-out, wherein the seal protection device comprises:
a base panel,
a first side panel forming an obtuse angle with the base panel, and
a second side panel forming an obtuse angle with the base panel, wherein the base panel is located between the first side panel and the second side panel;
rolling a wiper portion of the slide-out seal toward the RV by retracting the slide-out into the RV through the slide-out opening or cutout such that at least one of the first side panel and the second side panel contact the wiper portion of the slide-out seal; and
unrolling the wiper portion of the slide-out seal away from the RV by extending the slide-out outward through the slide-out opening or cutout such that at least one of the first side panel and the second side panel contact the wiper portion of the slide-out seal.

16. The method of claim 15, wherein at least a portion of the outer surface of the slide-out faces toward the slide-out seal during the retracting and the extending of the slide-out.

17. The method of claim 15, wherein the attaching comprises securing the base panel to the outer surface of the slide-out via an adhesive backing on the base panel.

18. The method of claim 15, wherein attaching the at least one seal protection device comprises attaching a first seal protection device and a second seal protection device vertically or horizontally aligned with each other on a single face of the outer surface of the slide-out along a device axis that is substantially parallel to a seal axis of the slide-out seal.

19. The method of claim 15, wherein attaching the at least one seal protection device comprises attaching at least two seal protection devices on each of a top surface, a bottom surface, and two opposing side surfaces of the slide-out.

20. The method of claim 15, wherein unrolling the wiper portion away from the RV comprises at least one of the first side panel and the second side panel contacting and guiding or flattening out the slide-out seal into a rolled-out or fully-extended configuration as the slide-out is extended outward.
